(19) United States
(12) Patent Application Publication
(10) Pub. No.: US 2008/0048578 A1
(43) Pub. Date: Feb. 28, 2008

(54) Projector HID lamp ballast having auxiliary resonant circuit

(76) Inventor: Matthew Beasley, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/467,543

(22) Filed: Aug. 26, 2006

(51) Int. Cl. H05B 41/36

(52) U.S. Cl. 315/224

(57) ABSTRACT

A ballast for a projector high-intensity discharge (HID) lamp includes a resonant converter and an auxiliary resonant circuit. The resonant converter is to convert and transmit power received from a power source to the projector HID lamp. The auxiliary resonant circuit is to selectively boost the power transmitted to the projector HID lamp.

### BACKGROUND

Projectors are devices that are commonly connected to computing devices or other devices that are capable of outputting image data, such as personal computers (PC's), digital versatile disc (DVD) players and other types of audio/visual (AV) equipment, and which display the image data for viewing purposes. A projector includes a light source, such as a lamp. One type of projector lamp is a high-intensity discharge (HID) lamp, such as a noble gas HID lamp. An issue with such projector noble gas HID lamps in particular is that after they have been ignited, they typically have to be sufficiently heated before they can operate in steady state at their designed operating voltages.

### BRIEF DESCRIPTION OF THE DRAWINGS

FIG. 1 is a rudimentary diagram of a representative projector having a high-intensity discharge (HID) lamp and a corresponding ballast, according to an embodiment of the invention.

FIG. 2 is a diagram of a ballast for a projector HID lamp and that has a resonant converter and an auxiliary resonant circuit, according to an embodiment of the invention.

FIG. 3 is a diagram of an LLC resonant converter for a projector HID lamp ballast, as one specific type of resonant converter, according to an embodiment of the invention.

FIG. 4 is a diagram of an auxiliary resonant circuit for a projector HID lamp ballast, according to a general embodiment of the invention.

FIG. 5 is a diagram of the auxiliary resonant circuit of FIG. 4 in more detail, according to an embodiment of the invention.

FIG. 6 is a diagram of the auxiliary resonant circuit of FIG. 4 in more detail, according to another embodiment of the invention.

FIG. 7 is a flowchart of a method for operating a ballast having a resonant converter and an auxiliary resonant circuit to ignite, heat, and then maintain constant power to a projector HID lamp, according to an embodiment of the invention.

### DETAILED DESCRIPTION OF THE DRAWINGS

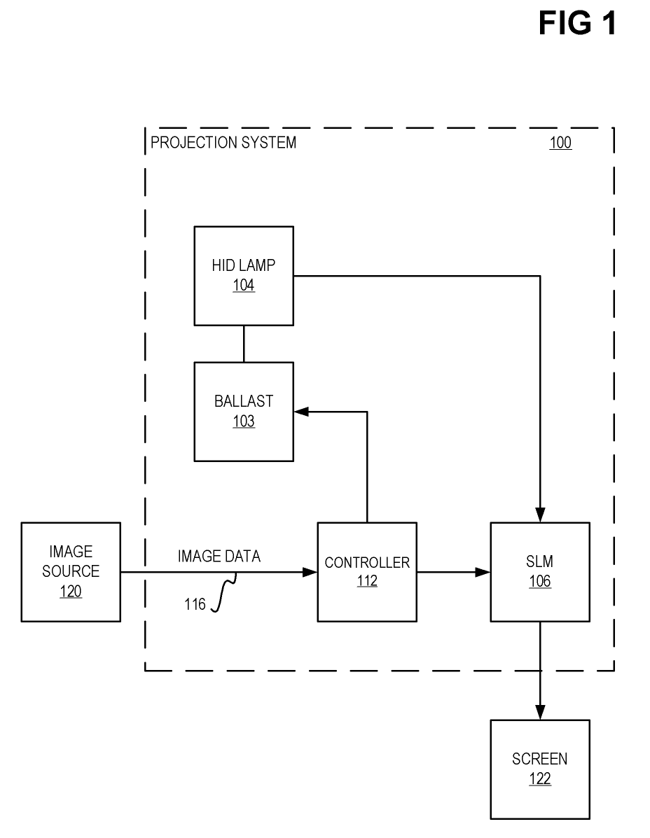

FIG. 1 shows a representative projection system 100 according to an embodiment of the invention. The system 100 may be implemented as a projector. As can be appreciated by those of ordinary skill within the art, the system 100 includes components specific to a particular embodiment of the invention, but may include other components in addition to or in lieu of the components depicted in FIG. 1. The projection system 100 includes a high-intensity discharge (HID) lamp 104, a ballast 103 for the HID lamp 104, a spatial light modulator 106, a controller 112 operatively or otherwise coupled to an image source 120 to receive image data 116, as well as a screen 122.

The HID lamp 104 outputs light, and is controlled by the ballast 103. The ballast 103 is an electrical component that controls the electrical power provided to the HID lamp 104 for operational purposes. The HID lamp 104 operates by establishing an arc between two electrodes within a gas-filled tube, which causes the gas to produce radiant energy. The electrodes of a projector HID lamp are typically separated by a very short distance, measured in millimeters, and the gas in the tube is very highly pressurized, allowing the arc to generate extremely high temperatures and causing a portion of the gas to become a plasma and release large amounts of visible radiant energy. In one embodiment, the gas of the HID lamp 104 is a noble gas, such as, but not limited to, xenon and argon.

Projector HID lamps differ from HID lamps used in other applications, such as automotive headlamp applications, in that projector HID lamps are much more highly pressurized, and have electrode gaps that are significantly smaller. As a result, whereas typical HID lamps are ignited at several times their normal operating voltage, and the voltage then decreases to the normal operating voltage, this type of operating methodology is inapplicable to projector HID lamps. A projector HID lamp typically is ignited at a lower voltage, and the voltage then increases to the normal operating voltage as the lamp warms up. Ballasts of the type normally used for HID lamps are not useful for projector HID lamps, because they typically are incapable of producing the lower steady-state operating voltages of the projector HID lamps.

Furthermore, noble gas projector HID lamps differ from other types of projector HID lamps, such as those that employ mercury vapor. In particular, the operating voltages of such noble gas projector HID lamps are generally significantly lower and the operating currents of these noble gas projector HID lamps are generally significantly higher than those of other types of projector HID lamps. As such, conventional ballasts employed for non-noble gas projector HID lamps are not well adapted for use in relation to noble gas projector HID lamps.

In addition, a noble gas projector HID lamp differs from other types of projector HID lamps in that such a noble gas lamp is typically operated by first igniting the lamp at a relatively low voltage, which initiates ionization of the gas within the lamp across its electrodes. Thereafter, during a so-called boost phase, a cathode of the noble gas projector HID lamp is heated sufficiently to initiate thermionic emission. This boost phase serves to reduce the steady-state operating voltage at which the lamp is thereafter ultimately operated to continually output a predetermined amount of light until turned off.

The HID lamp 104 may in one embodiment be detachably connected to the ballast 103. Therefore, the HID lamp 104 may be replaced within the projection system 100 without having to replace the ballast 103, such that the lamp 104 and the ballast 103 are separate components. This can be advantageous, because typically the ballast 103 has a longer lifetime than the HID lamp 104 does. In another embodiment, however, the HID lamp 104 together with the ballast 103 constitutes an integrated lamp-ballast assembly, where the HID lamp 104 is permanently connected to the ballast 103. In this instance, when the HID lamp 104 burns out and/or the ballast 103 becomes non-operational, the assembly including the HID lamp 104 and the ballast 103 is replaced within the system 100, where the assembly as a whole is detachably connected within the system 100.

The light output by the HID lamp 104 is for ultimate modulation by the spatial light modulator (SLM) 106, which may be a digital micromirror device, or another type of SLM. The SLM 106 is more generally considered an image-display component of the projection system 100. The controller 112 controls the SLM 106 in accordance with the image data 116 received from the image source 120, and further controls the ballast 103 to appropriately turn on the HID lamp 104 when the projection system 100 is to display the image data 116. The controller 112 may be implemented in hardware, software, or a combination of hardware and software. The image source 120 may be a computing device, such as a computer, or another type of electronic and/or video device.

The light output by the HID lamp 104 is thus projected onto the SLM 106, and then outwards from the projection system 100, where it is displayed on the screen 122, or another physical object, such as a wall, and so on. The projection system 100 can and typically does include various optics components, such as mirrors, lenses, and so on, between the HID lamp 104 and the SLM 106 and/or between the SLM 106 and the screen 122, which are not depicted in the rudimentary diagram of the projection system in FIG. 1 for illustrative convenience and clarity. The screen 122 itself may be a front screen or a rear screen, such that the projection system 100 may be a front-projection system or a rear-projection system, as can be appreciated by those of ordinary skill within the art. The user of the projection system 100, and other individuals able to see the screen 122, are then able to view the image data 116.

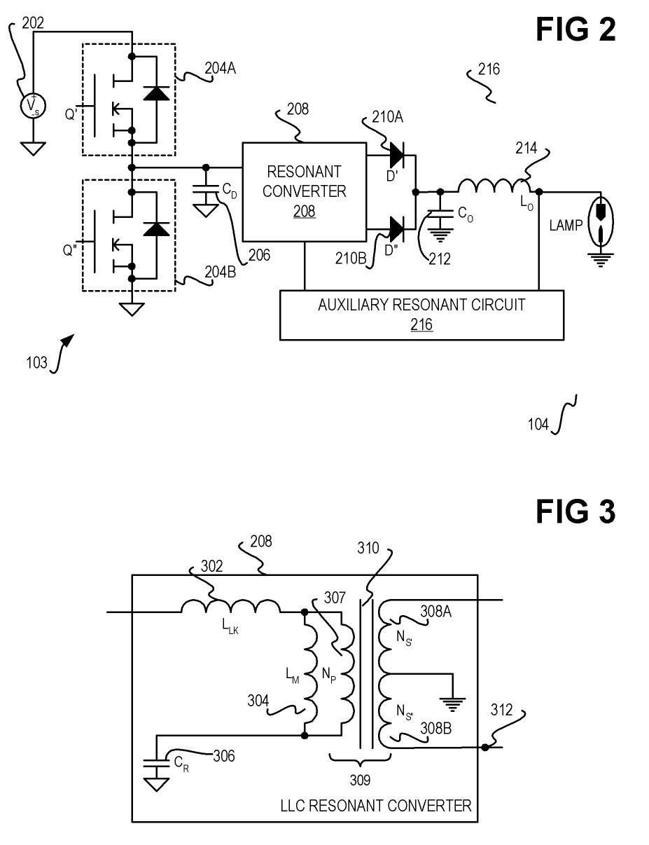

FIG. 2 shows the ballast 103 in detail, according to an embodiment of the invention. The ballast 103 converts and transmits power from a voltage (or power) source 202 to the HID lamp 104. The terms voltage source and power source are used synonymously herein. The voltage source 202 may be a 380-volt direct-current (DC) voltage source in one embodiment, and is connected to transistors 204A and 204B, collectively referred to as the transistors 204. The transistors 204, identified as transistors Q′ and Q″ in FIG. 2, are appropriately switched on and off to convert the DC voltage from the voltage source 202 into an alternating current (AC) voltage. The transistors 204 are more specifically switched in opposition at nearly full duty cycle, and the delay between the transistor 204A turning off and the transistor 204B turning on is adjusted to allow for zero-voltage switching operation. The transistors are more generally referred to as switching mechanisms.

A resonant converter 208 is connected between the transistors 204. As such, the resonant converter 208 is electrically coupled to the voltage source 202 via its connection between the transistors 204. A capacitor 206, identified as the capacitor C_{D} in FIG. 2, is connected in parallel with the resonant converter 208 between the transistors 204. The capacitor 206 provides a delay in the rise of the switching voltage to assist in the zero-voltage switching of the transistors 204. The resonant converter 208 is particularly the component of the ballast 103 that converts and transmits the power from the voltage source 202 to the HID lamp 104, in that it converts the power provided by the voltage source 202, as switched by the transistors 204, to the voltage needed by the lamp 104 to ignite and then subsequently operate at steady state.

Two diodes 210A and 210B, collectively referred to as the diodes 210, and identified as diodes D′ and D″ in FIG. 2, rectify the voltage provided by the resonant converter 208. This output voltage is transmitted to the lamp 104 via a capacitor 212 and an inductor 214, identified as the capacitor C₀ and the inductor L₀ in FIG. 2. In particular, the inductor 214 is connected between the diodes 210 and the lamp 104 to electrically couple the resonant converter 208 to the HID lamp 104, whereas the capacitor is connected to the diodes 210 in parallel to a circuit branch encompassing the inductor 214 and the HID lamp 104. The capacitor 212 and the inductor 214 act as a filter to remove the switching frequency from the voltage provided by the resonant converter 208 to the HID lamp 104.

An auxiliary resonant circuit 216 is connected or electrically coupled to the resonant converter 208 and to the HID lamp 104. The auxiliary resonant circuit 216 is the component of the ballast 103 that selectively boosts the power transmitted to the HID lamp 104. More specifically, the auxiliary resonant circuit 216 boosts the power transmitted to the HID lamp 104 after the lamp 104 has been ignited by the resonant converter 208, and before the lamp 104 is operated at a steady-state operating voltage to continuously output a predetermined amount of light until turned off. The auxiliary resonant circuit 216 specifically boosts the power transmitted to the HID lamp 104 to sufficiently heat the lamp 104. Such heating of the HID lamp 104, where the lamp 104 is a noble gas HID lamp in particular, can serve to reduce the steady-state operating voltage at which the lamp 104 is thereafter ultimately operated by the resonant circuit 216 alone to continually output a predetermined amount of light until turned off.

FIG. 3 shows the resonant converter 208 in detail, according to a particular embodiment of the invention. The resonant converter 208 of FIG. 3 is particularly an inductor-inductor-capacitor (LLC) resonant converter. The LLC resonant converter 208 is an LLC resonant converter in that it is made up of two inductors 302 and 304, identified as the inductors L_{LK} and L_{M} in FIG. 3, and one capacitor 306, identified as the capacitor C_{R}. The inductors 302 and 304 and the capacitor 306 are in series within one another. The inductors 302 and 304 are more generally inductive mechanisms, in that they may or may not be discrete components. For example, the inductor 302 in particular may be the inherent predesigned leakage inductance of a transformer 309 of the LLC resonant converter 208, such that it is not a discrete component. By comparison, the inductor 304 may be a discrete magnetizing inductor of the transformer 309.

The LLC resonant converter 208 varies in design from other types of resonant converters, at least because it is made up of two inductors 302 and 304 and one capacitor 306. By comparison, an LCC resonant converter is made up of a single inductor and two capacitors. Similarly, an LCLC resonant converter is made up of two inductors and two capacitors. Furthermore, the LLC resonant converter 208 specifies the order in which its components are connected. In particular, the first inductor 302 is connected in series to the second inductor 304, and the capacitor 306 is connected in series to the second inductor 304.

The LLC resonant converter 208 is a “resonant” converter in that it has at least one switching frequency of power input thereto (as switched by the transistors 204) at which the inductors 302 and/or 304 are in resonance with the capacitor 306. More particularly, the LLC resonant converter 208 is a multiple-mode resonant converter, or a multiply resonant converter, in that it has more than one, and specifically two, switching frequencies of power input thereto at which the inductors 302 and/or 304 are in resonance with the capacitor 306. In this latter instance in particular, the LLC resonant converter 208 is distinguished from other types of resonant converters that may only have one resonant frequency.

However, more generally, other types of resonant converters may be employed in lieu of the LLC resonant converter 208 within the ballast 103. The LLC resonant converter 208, in other words, is a particular type of resonant converter that is used in just one specific embodiment of the invention. Thus, in other embodiments of the invention, other types of resonant converters, such as LCC resonant converters, LCLC resonant converters, and so on, may be employed. In general, a resonant converter employed within the ballast 103 desirably is a multiple-mode, or variable, resonant converter having more than one switching frequency of power input thereto at which the converter has resonant frequencies.

With particular respect to the LLC resonant converter 208, the first resonant frequency is the frequency at which the inductor 302 by itself is in resonance with the capacitor 306, such that the inductance of the inductor 302 alone (i.e., not including the inductor 304) in combination with the capacitance of the capacitor 306 controls the value of this frequency. This resonant frequency can be expressed mathematically as:

$${f}_{1} = \frac{1}{2 π \sqrt{{L}_{LK} {C}_{R}}} . \qquad ( 1 )$$

The first resonant frequency is that by which the needed voltage to the HID lamp 104 to ignite the HID lamp 104 is provided. This voltage can be lower than the operating voltage of the HID lamp 104 at which the HID lamp 104 operates after ignition and outputs a predetermined amount of light. Thus, the transistors 204 are switched at a switching frequency equal to the first resonant frequency when the HID lamp 104 is to be ignited.

The second resonant frequency of the LLC resonant converter 208 is the frequency at which the inductor 302 and the inductor 304 in combination are in resonance with the capacitor 306, such that the inductances of the inductor 302 and 304 in combination with the capacitance of the capacitor 306 control the value of this frequency. This resonant frequency can be expressed mathematically as:

$${f}_{2} = \frac{1}{2 π \sqrt{( {L}_{LK} + {L}_{M} ) {C}_{R}}} . \qquad ( 2 )$$

The second resonant frequency controls, or limits, the voltage provided to the HID lamp 104 prior to ignition of the lamp 104. That is, when the HID lamp 104 has not yet been ignited, the transistors 204 are switched at a switching frequency equal to the second resonant frequency so that the voltage provided to the HID lamp 104 is not too high.

Furthermore, operation at a switching frequency between the two resonant frequencies maintains a substantially constant output power being provided to the HID lamp 104 after the lamp 104 has been ignited, and substantially irrespective of the operating voltage of the HID lamp 104. As the HID lamp 104 ages, the operating voltage of the HID lamp 104 increases. The operating voltage of the HID lamp 104 is the voltage at which the lamp 104 operates after ignition and after it has warmed up, to output a substantially constant predetermined amount of light. That the operating voltage of the HID lamp 104 increases with age means that the output power provided to the HID lamp 104 has to be substantially constant regardless of the operating voltage of the HID lamp 104. Where the operating voltage is lower when the HID lamp 104 is new, more current has to be provided to maintain a given output power and for the lamp 104 to output the same predetermined amount of light, as compared to where the operating voltage is higher when the HID lamp 104 is old, in which case less current has to be provided to maintain this same output power.

Therefore, LLC resonant converter 208 is advantageous at least because it ensures that a substantially constant output power is provided to the HID lamp 104 throughout the lifetime of the lamp 104, as the operating voltage of the HID lamp 104 increases with age. In particular, the ratio between the inductance of the inductor 302 and the inductance of the inductor 304, as well as the overall impedance of the LLC resonant converter 208, can be selected to ensure substantially constant output power even over a substantially two-to-one range of operating voltage of the HID lamp 104. That is, even where the operating voltage of the HID lamp 104 when old (i.e., at end of life) is substantially twice that of the operating voltage of the lamp 104 when new (i.e., at beginning of life), the LLC resonant converter 208 can provide for substantially constant output power to the HID lamp 104.

Furthermore, the operating frequency can remain constant (between the first and the second resonant frequencies), or change minimally, for the LLC resonant converter 208 to provide substantially constant output power to the HID lamp 104 over the lifetime of the lamp 104, as the operating voltage of the HID lamp 104 increases with age. For example, the ballast 103 may provide 300 watts in output power to the HID lamp 104, from a 380-volt DC voltage source 202. It has been found in such instance that the operating frequency may have to change by just 4% to provide this constant output power where the HID lamp 104 has an operating voltage of 25 volts when old, as compared to where the lamp 104 has an operating voltage of 12 volts when new.

The power from the voltage source 202 as switched by the transistors 204 is thus regulated by the inductors 302 and 304 and the capacitor 306 based on the switching frequency of the transistors 204 in relation to the two resonant frequencies of the LLC resonant converter 208. The LLC resonant converter 208 also includes the transformer 309. The transformer 309 serves to transfer the electrical power from the voltage source 202, as switched by the transistors 204 and as regulated by the inductors 302 and 304 and the capacitor 306, ultimately to the lamp 104, as can be appreciated by those of ordinary skill within the art.

The transformer 309 has primary windings 307, identified in FIG. 3 as the windings N_{P}, wound around a magnetic core 310 thereof on the input side. The transformer 309 further has and two sets of secondary windings 308A and 308B, collectively referred to as the secondary windings 308 and identified in FIG. 3 as the windings N_{S′} and N_{S″} wound around the magnetic core 310 thereof on the output side. The primary windings 307 are electrically connected in series with the inductor 302 and in parallel with the inductor 304. The secondary windings 308 provide the output of the LLC resonant converter 208, and thus are ultimately electrically coupled to the HID lamp 104. There is further a connection to ground between the secondary windings 308, as depicted in FIG. 3. Finally, one output 312 of the LLC resonant converter 208 is particularly called out in FIG. 3.

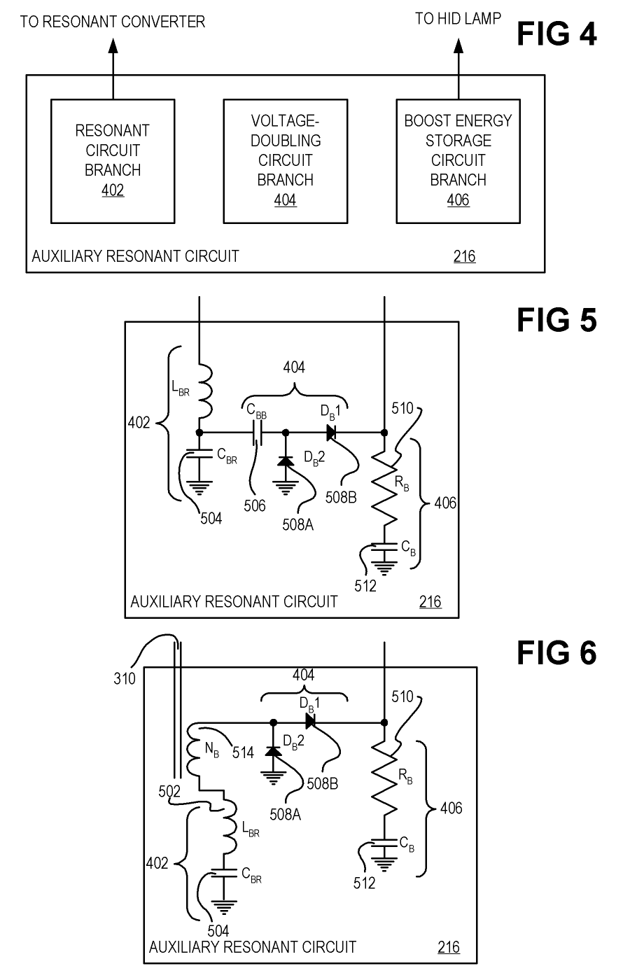

FIG. 4 shows the auxiliary resonant circuit 216 in detail, according to a particular embodiment of the invention. The auxiliary resonant circuit 216 selectively boosts the power transmitted to the projector HID lamp 104. Such boosting is selective in that the power is boosted just when needed. Specifically, the power is boosted to sufficiently heat projector HID lamp 104, so that it can be subsequently operated at a reduced operating voltage to continuously output a predetermined amount of light until turned off.

The auxiliary resonant circuit 216 includes three circuit branches in the embodiment of FIG. 4: a resonant circuit branch 402, a voltage-doubling circuit branch 404, and a boost energy storage circuit branch 406. The resonant circuit branch 402 is connected and electrically coupled to the resonant converter 208. The boost energy storage circuit branch 406 is connected and electrically coupled to the HID lamp 104. The voltage-doubling circuit branch 404 is connected and electrically coupled between the resonant circuit branch 402 and the boost energy storage circuit branch 406.

The resonant circuit branch 402 and thus the auxiliary resonant circuit 216 as a whole have a resonant frequency at which current flows therethrough from the resonant converter 208. When the switching frequency of the ballast 103 (i.e., the frequency at which the transistors 204 are switched on and off) is not at this resonant frequency, the resonant circuit branch 402, and thus the auxiliary resonant circuit 216 as a whole, otherwise have sufficient impedance to present minimal loading to the resonant converter 208. Furthermore, when the ballast 103 is switching at a frequency equal to the resonant frequency at which the resonant converter 208 ignites the HID lamp 104, limited current may flow through the resonant circuit branch 402.

The voltage-doubling circuit branch 404 of the auxiliary resonant circuit 216 rectifies the voltage provided by the resonant circuit branch 402. Due to this rectification, the voltage provided by the resonant circuit branch 402 is doubled. The current flowing through the auxiliary resonant circuit 216 when the switching frequency of the ballast 103 is at the resonant frequency of the circuit 216 results in energy being stored by the boost energy storage circuit branch 406. The energy stored by the boost energy storage circuit branch 406 is that which boosts the power transmitted to the HID lamp 104 for heating purposes.

FIG. 5 shows the auxiliary resonant circuit 216 of FIG. 4 in detail, according to a specific embodiment of the invention. The auxiliary resonant circuit 216 of FIG. 5 is a parallel resonant circuit, because the capacitive mechanism 504 is in parallel with the capacitive mechanism 506 from the perspective of the inductive mechanism 502. The inductive mechanism 502 such as an inductor and identified as L_{BR} in FIG. 5, and the capacitive mechanism 504, such as a capacitor and identified as C_{BR} in FIG. 5, particularly make up the resonant circuit branch 402 in the embodiment of FIG. 5.

The inductive mechanism 502 of the resonant circuit branch 402 can be connected to the output 312 of the LLC resonant converter 208 of FIG. 3. The inductive mechanism 502 is connected in series with the capacitive mechanism 504, which is connected to ground. The resonant circuit branch 402 has a switching frequency of power input thereto (as switched by the transistors 204, and as transmitted via the resonant converter 208) at which the inductive mechanism 502 is in resonance with the capacitive mechanism 504. This resonant frequency can be expressed mathematically as:

$${f}_{BR} = \frac{1}{2 π \sqrt{{L}_{BR} {C}_{BR}}} . \qquad ( 3 )$$

### This resonant frequency is that at which current flows through the inductive mechanism 502 and the capacitive mechanism 504.

The voltage-doubling circuit branch 404 of the auxiliary resonant circuit 216 of FIG. 5 includes the capacitive mechanism 506, such as a capacitor and identified as C_{BB} in FIG. 5, and two diodes 508A and 508B, collectively referred to as the diodes 508 and identified as D_{B}1 and D_{B}2 in FIG. 5. Particularly, an input of the capacitive mechanism 506 is connected between the inductive mechanism 502 and the capacitive mechanism 504 of the resonant circuit branch 402, and an output of the capacitive mechanism 506 is connected to an output of the diode 508A and to an input of the diode 508B. Thus, the diode 508B is electrically coupled to the resonant circuit branch 402 through the capacitive mechanism 506. An input of the diode 508A is connected to ground, and an output of the diode 508B is connected to the HID lamp 104. The capacitive mechanism 506 and the diodes 508 rectify the voltage provided over the capacitive mechanism 504, effectively doubling this voltage.

The boost energy storage circuit branch 406 of the auxiliary resonant circuit 216 of FIG. 5 includes, in series connection, a resistive mechanism 510, such as a resistor and identified as R_{B} in FIG. 5, and a capacitive mechanism 512, such as a capacitor and identified as C_{B} in FIG. 5. Particularly, the resistive mechanism 510 has one end connected to the HID lamp 104 and to the output of the diode 508B, and the other end connected to the capacitive mechanism 512. The capacitive mechanism 512 has one end connected to the resistive mechanism 510, and the other end connected to ground.

When the switching frequency of the ballast 103 is at the resonant frequency of the auxiliary resonant circuit 216, current flows through the circuit 216. The resulting voltage as provided over the boost energy storage circuit branch 406 is doubled by the voltage-doubling circuit branch 406. This voltage in turn charges the capacitive mechanism 512. The power provided to the HID lamp 104 is thus boosted as a result of the current discharging from the capacitive mechanism 512 to the HID lamp 104 through the resistive mechanism 510. When the HID lamp 104 has been sufficiently heated, the switching frequency of the ballast 103 can be set equal to a frequency other than the resonant frequency of the auxiliary resonant circuit 216, to halt the boost in power provided to the HID lamp 104.

The parallel auxiliary resonant circuit 216 of FIG. 5 provides for a voltage over the boost energy storage circuit branch 406 that can be, for instance, four or five times greater than the voltage at the output 316 of the resonant converter 208. This is because the capacitance of the capacitive mechanism 504 and the inductance of the inductive mechanism 502 can be selected so that the voltage over the capacitive mechanism 504 can be, for instance, two or two-and-a-half times greater than the voltage at the output 316. After doubling by the voltage-doubling circuit branch 404, the voltage over the boost energy storage circuit branch 406 can thus be four or five times greater than the voltage at the output 316.

FIG. 6 shows the auxiliary resonant circuit 216 of FIG. 4 in detail, according to another specific embodiment of the invention. The auxiliary resonant circuit 216 of FIG. 6 is a series resonant circuit, because the inductive mechanism 502 is in series with the capacitive mechanism 504. Furthermore, the resonant circuit branch 402 of the auxiliary resonant circuit 216 includes windings 514, identified as N_{B} in FIG. 6, of and thus electrically coupled to the magnetic core 310 of the resonant converter 208. That is, the magnetic core 310, besides having the windings 307 and 308, also include the windings 514, which are particularly considered part of the auxiliary resonant circuit 216 in FIG. 6.

Otherwise, the auxiliary resonant circuit 216 of the embodiment of FIG. 6 is substantially similar in operation and in details as that of the embodiment of FIG. 5. The inductive mechanism 502, such as an inductor and identified as L_{BR} in FIG. 6, and the capacitive mechanism 504, such as a capacitor and identified as C_{BR} in FIG. 6, besides the windings 514, make up the resonant circuit branch 402 in the embodiment of FIG. 6. The inductive mechanism 502 is connected in series with the capacitive mechanism 504, which is connected to ground.

As in the embodiment of FIG. 5, the resonant circuit branch 402 in the embodiment of FIG. 6 has a switching frequency of power input thereto (as switched by the transistors 204, and as transmitted via the resonant converter 208) at which the inductive mechanism 502 is in resonance with the capacitive mechanism 504. This resonant frequency can be expressed mathematically as in Equation (3) above. This resonant frequency is that at which current flows through the inductive mechanism 502 and the capacitive mechanism 504.

The voltage-doubling circuit branch 404 of the auxiliary resonant circuit 216 of FIG. 6 includes two diodes 508A and 508B, collectively referred to as the diodes 508 and identified as D_{B}1 and D_{B}2 in FIG. 6. Particularly, an input of the diode 508A is connected to ground, and an output of the diode 508A is connected to an input of the diode 508B. The input of the diode 508B is connected to the windings 514 of the resonant circuit branch 402, and an output of the diode 508B is connected to the HID lamp 104. The diodes 508 rectify the voltage provided over the capacitive mechanism 504, effectively doubling this voltage.

As in the embodiment of FIG. 5, the boost energy storage circuit branch 406 of the auxiliary resonant circuit 216 of FIG. 6 includes, in series connection, a resistive mechanism 510, such as a resistor and identified as R_{B} in FIG. 6, and a capacitive mechanism 512, such as a capacitor and identified as C_{B} in FIG. 6. Particularly, the resistive mechanism 510 has one end connected to the HID lamp 104 and to the output of the diode 508B, and the other end connected to the capacitive mechanism 512. The capacitive mechanism 512 has one end connected to the resistive mechanism 510, and the other end connected to ground.

As in the embodiment of FIG. 5, when the switching frequency of the ballast 103 is at the resonant frequency of the auxiliary resonant circuit 216 of FIG. 6, current flows through the circuit 216. The resulting voltage as provided over the boost energy storage circuit branch 406 is doubled by the voltage-doubling circuit branch 406. This voltage in turn charges the capacitive mechanism 512. The power provided to the HID lamp 104 is thus boosted as a result of the current discharging from the capacitive mechanism 512 to the HID lamp 104 through the resistive mechanism 510. When the HID lamp 104 has been sufficiently heated, the switching frequency of the ballast 103 can be set equal to a frequency other than the resonant frequency of the auxiliary resonant circuit 216, to halt the boost in power provided to the HID lamp 104.

The series auxiliary resonant circuit 216 of FIG. 6 provides for a voltage to the boost energy storage circuit branch 406 that is just two times greater than the voltage at the windings 514 of the transformer 309, in contradistinction to the parallel resonant circuit 216 of FIG. 5. This is because the voltage over the boost energy storage circuit branch 406 is the same as that at the windings 514 of the transformer 309, but for the doubling thereof by the voltage-doubling circuit branch 404. Thus, the winding ratio of these separate windings 514 on the transformer 309 can be selected to provide for the desired ratio between the normal output voltage and the boost voltage.

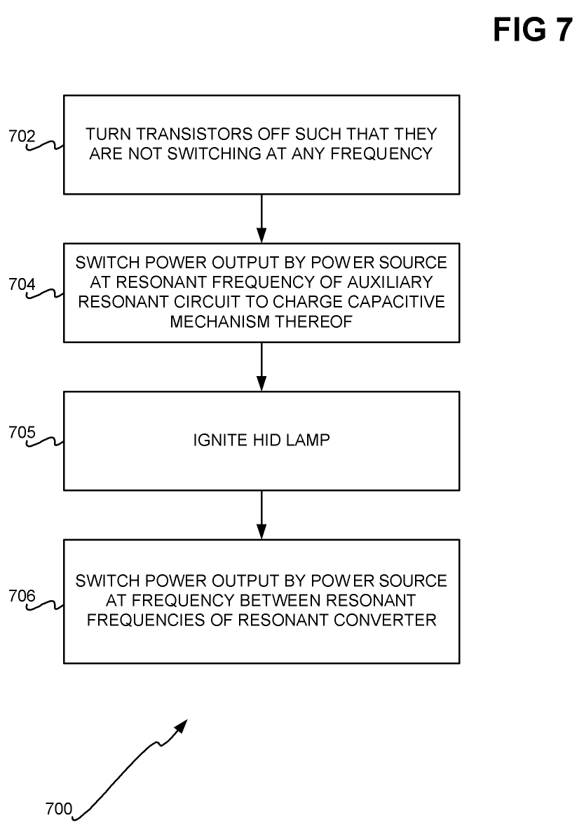

FIG. 7 shows a method 700 for operating the ballast 103 having the resonant converter 208, according to an embodiment of the invention. The method 700 may be performed by the controller 112 of FIG. 1, for instance. The method 700 may further be implemented as a computer program stored on a tangible computer-readable medium.

Before the HID lamp 104 is operating, the transistors 204 are off (702), such that they are not being switching on and off at any frequency. As a result, none of the power from the voltage source 202 is provided to the resonant circuit 208 or to the auxiliary resonant circuit 216, such that no power is provided to the HID lamp 104. Thereafter, when operation of the HID lamp 104 is desired, the transistors 204 are switched at a frequency equal to the resonant frequency of the auxiliary resonant circuit 216 (704). As a result, the capacitive mechanism 512 of the auxiliary resonant circuit 216 is charged.

Once the capacitive mechanism 512 of the auxiliary resonant circuit 216 has been charged, the HID lamp 104 is ignited (705). The power supplied to the HID lamp 104 by the resonant converter 208 is thus boosted by the auxiliary resonant circuit 216. Finally, once the HID lamp 104 has been ignited, the power output by the voltage source 202 is switched at a frequency between the two resonant frequencies of resonant converter 208 (706), as has been described.

It is noted that the energy from the capacitive mechanism 512 flows through the resistor 510 of the auxiliary resonant circuit 216 to heat the cathode of the HID lamp 104 sufficiently. As a result of this heating, the voltage over the HID lamp 104 decreases, enabling the resonant converter 208 to supply the needed operating power to the HID lamp 104 when the operating frequency is between the two resonant frequencies of the converter 208. Furthermore, the significant difference in the resonant frequencies of the auxiliary resonant circuit 216 and the resonant converter 208 results in the auxiliary circuit drawing minimal power from the resonant converter 208 when the operating frequency is between the two resonant frequencies of the resonant converter 208.

I claim:

1. A ballast for a projector high-intensity discharge (HID) lamp, comprising:
a resonant converter to convert and transmit power received from a power source to the projector HID lamp; and,
an auxiliary resonant circuit to selectively boost the power transmitted to the projector HID lamp.

2. The ballast of claim 1, wherein the resonant converter is to ignite the projector HID lamp and to maintain output power provided to the projector HID lamp so that the projector HID lamp outputs a predetermined amount of light, and
wherein the auxiliary resonant converter is to boost the power transmitted to the projector HID lamp after ignition of the projector HID lamp to heat the projector HID lamp before the resonant converter maintains the output power provided to the projector HID lamp.

3. The ballast of claim 1, wherein the auxiliary resonant circuit has a resonant frequency at which current flows from the resonant converter so that energy is stored within the auxiliary resonant circuit to boost the power transmitted to the projector HID lamp.

4. The ballast of claim 3, wherein the auxiliary resonant circuit comprises an inductive mechanism and a capacitive mechanism, an inductance of the inductive mechanism and a capacitance of the capacitive mechanism controlling the resonant frequency of the auxiliary resonant circuit.

5. The ballast of claim 1, wherein the auxiliary resonant circuit is a parallel resonant converter.

6. The ballast of claim 1, wherein the auxiliary resonant circuit is a series resonant circuit.

7. The ballast of claim 1, wherein the auxiliary resonant circuit comprises:
a resonant circuit branch connected to the resonant converter and having a resonant frequency at which current flows from the resonant converter; and,
a boost energy storage circuit branch electrically coupled to the resonant circuit branch to store energy when the current flows through the resonant circuit branch that is to boost the power transmitted to the projector HID lamp.

8. The ballast of claim 7, wherein the resonant circuit branch is connected to an output of a transformer of the resonant circuit.

9. The ballast of claim 7, wherein the resonant circuit branch comprises windings electrically coupled to a magnetic core of a transformer of the resonant circuit.

10. The ballast of claim 7, wherein the resonant circuit branch comprises:
an inductive mechanism; and,
a capacitive mechanism in series with the inductive mechanism,
wherein an inductance of the inductive mechanism and a capacitance of the capacitive mechanism control the resonant frequency of the resonant circuit branch.

11. The ballast of claim 7, wherein the boost energy storage circuit branch comprises:
a resistive mechanism electrically coupled to the projector HID lamp; and,
a capacitive mechanism connected in series with the resistive mechanism,
wherein the current flowing through the resonant circuit branch flows through the resistive mechanism to the capacitive mechanism, the capacitive mechanism storing the energy that is used to boost the power transmitted to the projector HID lamp.

12. The ballast of claim 7, wherein the auxiliary resonant circuit further comprises a voltage-doubling circuit branch connected between the resonant circuit branch and the boost energy storage circuit branch.

13. The ballast of claim 12, wherein the voltage-doubling circuit branch comprises:
a first diode having an input electrically coupled to the resonant circuit branch, and an output connected to the boost energy storage circuit branch; and,
a second diode having an input connected to ground and an output connected to the input of the first diode.

14. The ballast of claim 13, wherein the voltage-doubling circuit branch further comprises a capacitor having a first end connected between the inductive mechanism and the capacitive mechanism of the resonant circuit branch, and a second end connected to the input of the first diode.

15. A projector comprising:
a projector high-intensity discharge (HID) lamp to output light;
a ballast having a resonant converter to convert and transmit power received from a power source to the projector HID lamp, and an auxiliary resonant circuit to selectively boost the power transmitted to the projector HID lamp; and,
an image-display component to modulate the light in accordance with image data to be displayed by the projector.

16. The projector of claim 15, wherein the resonant converter is to ignite the projector HID lamp and to maintain output power provided to the projector HID lamp so that the projector HID lamp outputs a predetermined amount of light, and
wherein the auxiliary resonant converter is to boost the power transmitted to the projector HID lamp after ignition of the projector HID lamp to sufficiently heat the projector HID lamp before the resonant converter maintains the output power provided to the projector HID lamp.

17. The projector of claim 15, wherein the auxiliary resonant circuit has a resonant frequency at which current flows from the resonant converter so that energy is stored within the auxiliary resonant circuit to boost the power transmitted to the projector HID lamp, and
wherein the auxiliary resonant circuit comprises an inductive mechanism and a capacitive mechanism, an inductance of the inductive mechanism and a capacitance of the capacitive mechanism controlling the resonant frequency of the auxiliary resonant circuit.

18. The projector of claim 15, wherein the projector HID lamp comprises a projector noble gas HID lamp.

19. A method comprising:
switching power output by a power source at a frequency equal to a resonant frequency of an auxiliary resonant circuit, to charge a capacitive mechanism thereof;
igniting a projector high-intensity discharge (HID) lamp, such that the auxiliary resonant circuit boosts the power transmitted to the projector HID lamp to heat the projector HID lamp; and,
switching power output by the power source at a frequency between a first resonant frequency and a second resonant frequency of a resonant converter, such that the resonant converter maintains a substantially constant output power provided to the projector HID lamp.

20. The method of claim 19, wherein the resonant frequency of the auxiliary resonant circuit is that at which current flows from the resonant converter so that energy is stored within the auxiliary resonant circuit to boost the power transmitted to the projector HID lamp, and
wherein the auxiliary resonant circuit comprises an inductive mechanism and a second capacitive mechanism, an inductance of the inductive mechanism and a capacitance of the second capacitive mechanism controlling the resonant frequency of the auxiliary resonant circuit.
